(19) United States
(12) Patent Application Publication
(10) Pub. No.: US 2004/0124637 A1
(43) Pub. Date: Jul. 1, 2004

(54) AUTOMATIC POWER SUPPLY FOR HANDHELD REMOTE CONTROL UNIT

(76) Inventor: Reza H. Shah, Acton (CA)

Correspondence Address: DAVID W. WONG, 46 WILLOWBROOK ROAD, THORNHILL, ON, L3T 4W9, CA

(21) Appl. No.: 10/329,943

(22) Filed: Dec. 27, 2002

(51) Int. Cl. H02P 9/14

(52) U.S. Cl. 290/1 A; 290/1 C; 322/46

(57) ABSTRACT

An automatic power supply device for a remote control unit is shown. The device has a rotatable multi-layer disc mounted in an open top casing with a tray slidably mounted in it. The remote control unit is mounted on the tray which is movable up and down when a button of the remote control unit is pressed and released. The disc has printed wire provided in the same area of all layers. The area is located in a spaced manner between magnetic plates mounted in the inside surface of the arms of a U-shaped stator member. Current is generated in the printed wire when the disc is rotated. A capacitor is charged by the current to provide the voltage supply to operate the remote control unit.

### FIELD OF INVENTION

This invention relates to a device for generating an electrical power, and more particularly relates to a device operative for providing an electrical supply to a handheld remote control unit which only requires to operate intermittently.

### BACKGROUND OF THE INVENTION

Handheld battery operated remote control units are widely used in electrical appliances such as television, audio and video equipment, and other remote-controlled electronic and electrical devices. Some remote-controlled units consume a large amount of power due to their continuous operation during use while others such as the remote control unit for a television, consume less power since they are operated occasionally and only for a short instance. Nonetheless, all batteries of remote control units must be replaced from time to time when their power has been depleted. As control units use a variety of different sizes of batteries, it has been very frustrating for the users to obtain the correct sizes of batteries for replacement. Furthermore, most batteries contain materials that are harmful to the natural environment or would cause an explosion if negligently disposed of in a hot atmosphere. Thus, batteries must be disposed of with special care rather than just with common garbage in order not to cause pollution of the environment or an accidental explosion. For the above reasons, it is highly desirable to eliminate the use of batteries in remote control units.

### SUMMARY OF THE INVENTION

It is a principal object of the present invention to provide a device which may be incorporated to a remote control unit to generate the electrical supply required automatically whenever the remote control unit is operated.

It is another object of the present invention to provide a device which is small in size such that it would not increase the physical size of the remote control unit.

It is another object of the present invention to provide a device which can be easily attached to or integrally incorporated in a remote control unit which only requires to operate intermittently.

It is yet another object of the present invention to provide a device which is simple in construction and is easy to operate.

### BRIEF DESCRIPTION OF THE DRAWINGS

This invention may take physical form in certain parts and arrangements of parts, preferred embodiments of which will be described in detail in this specification and illustrated in the accompanying drawings which form a part hereof and wherein:

FIG. 1 is a perspective top elevation view of the basic components of the device of the present invention operative for generating the electrical supply for a remote control unit.

FIG. 2 is a sectional elevation view along section line II-II of FIG. 1.

FIG. 3 is a perspective bottom elevation of the mechanical components of the device of the present invention.

FIG. 4 is a sectional elevation view along section line IV-IV of FIG. 3.

FIG. 5 is an isolated side elevation view of an alternative embodiment of the mechanical components of the device of the present invention.

FIG. 6 is an electrical schematic diagram of the device of the present invention.

FIG. 7 is an electrical schematic diagram of the alternative embodiment of the present invention.

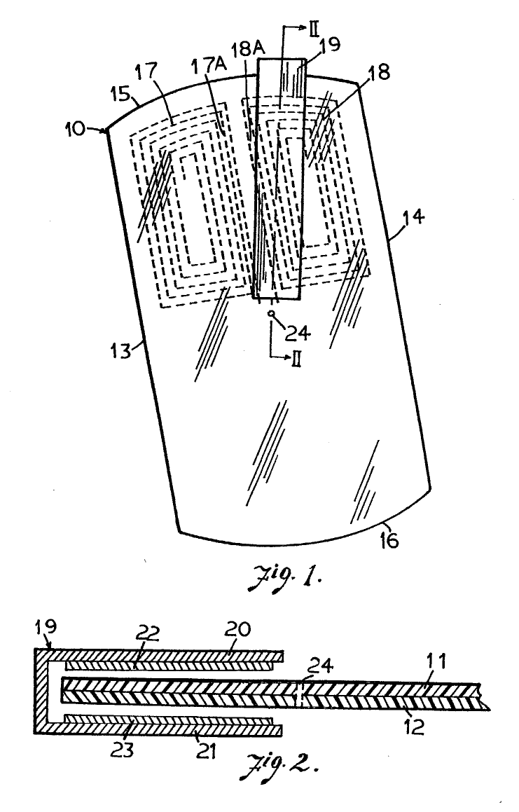

### DETAILED DESCRIPTION OF THE PREFERRED EMBODIMENTS

With reference to the drawings in which same reference numerals designate like parts in the several views, the device of the present invention has a multi-layer printed circuit disc 10. For simplicity of illustration, only two layers 11 and 12 are shown. The disc 10 is made of a circular disc with two truncated straight parallel opposite sides 13 and 14 and two opposite arcuate sides 15 and 16. A first spiral wire pattern 17 is printed on the left side of one half of each disc, and a second spiral wire pattern 18 is printed on its right side. The wire of the first spiral wire 17 of all the layers are connected together in series to form a first effective elongated wire and similarly the wire of the second spiral wire pattern 18 of all the layers are connected in series to form a second effective elongated wire.

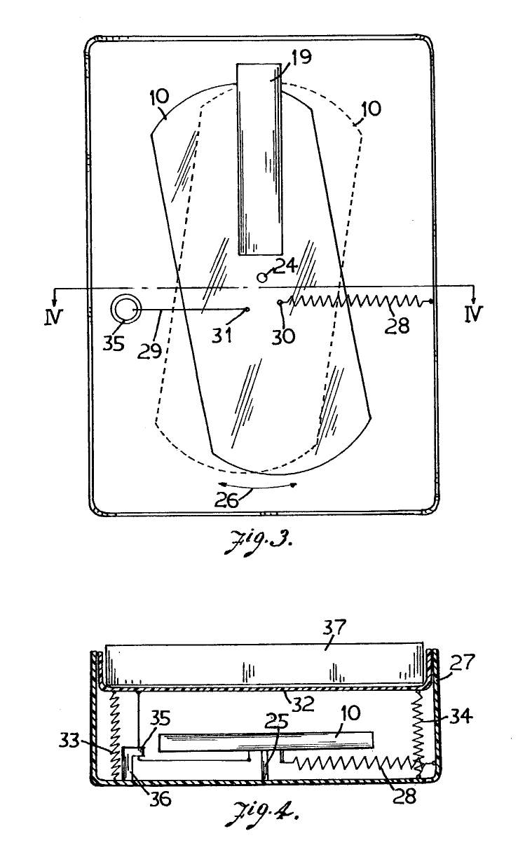

The disc 10 is located in a spaced manner between a U-shaped stator member 19 which has two spaced arms 20 and 21 with permanent magnetic plates 22 and 23 mounted on their inner surfaces respectively therein. The magnetic plates 22 and 23 are spaced from and adjacent to the half of the disc 10 having the printed wire patterns 17 and 18. The disc 10 may be rotated relative to its center 24 mounted on a shaft 25 to swing back and forth as shown by the arrow 26 as shown in FIG. 3 such that the vertical elongated portions 17A and 18A the printed wire patterns 17 and 18 are swung back and forth between the stator member 19. The motion of the disc 10 is inside the homopolar magnetic field between the magnetic plates 22 and 23. Thus an electric current is generated in the elongated portions 17A and 18A of the printed wire of each wire pattern when they move past the homopolar magnetic field between the magnetic plates 22 and 23.

Although the multi-layer disc 10 is preferably shaped as shown, which provides a balanced weight for the disc to rotate or swing in a smooth motion relative to the shaft mounted at its center, it will be appreciated by those skilled in the art that it may be of other shapes having the printed wire patterns provided thereon for the same purposes as long as the portion of the vertical elongated portions of the printed wire patterns may be swung back and forth in the space between the stator magnetic plates 22 and 23.

As best shown in FIGS. 3 and 4, the stator member 19 is mounted to a casing 27. The shaft 25 supporting the disc 10 is also mounted in the casing 27 such that the disc 10 may be rotated on the shaft 25 in a spaced manner within the arms of stator member 19. The disc 10 is preferably and normally maintained in a skewed position relative to the longitudinal axis of the stator member 19 by the pulling action between a tension spring 28 and a sliding string 29 in order that all printed wire therein pass through the homopolar magnetic field of the magnetic plates 22 and 23. One end of the spring 28 is mounted to a location 30 of the disc 10 which is offset the center 24 of the disc. As shown in FIG. 3 the location 30 is offset to the right at a short distance below the center 24 of the disc 10. The sliding string 29 has one end mounted to a second location 31 which is opposite to the location 30 and is offset to the left below the center 24 of the disc. The other end of the sliding string 29 is mounted to the bottom of a movable tray 32 which is located above and within the casing 27 and is movable slidably in an up and down manner therein. The tray 32 is maintained in the mounted slidable position by compression springs mounted between the tray 32 and the casing 27. Two compression springs 33 and 34 are shown for illustration purposes. The sliding string 29 is threaded through a guide ring 35 provided on a support post 36 which is mounted in the casing 27. The cooperation of the spring force of the compression springs 33 and 34, the pulling force of the tension spring 28 as well as the pulling force of the sliding string 29 maintain the disc 10 normally in the desirable skewed position with the elongated portions 18A of the right printed wire pattern 18 located in the homopolar magnetic field of the magnetic plates.

The remote control unit 37 is mounted in the tray 32. When any button of the remote control unit 37 is depressed during operation, the downward pressure will cause the string 29 to be pulled downward by the tension spring 28 so that the disc 10 is pulled by the tension spring 28 to rotate about its mounting shaft 25, thus moving the elongated portions 17A and 18A of the printed wire patterns 17 and 18 to move past the homomagnetic field between the magnetic plates 22 and 23. Subsequently, when the depressing pressure is released from button of the remote control unit 36, the compression springs 33 and 34 will pull the sliding string 29 backward so as to cause the disc 10 to rotate in the reverse direction so that the vertical elongated portions 17A and 18A of the printed wire patterns 17 and 18 will again pass through the homopolar magnetic field between the magnetic plates 22 and 23. Thus, by pressing and releaseing any button of the remote control unit 37 or alternatively on the body of the remote control unit itself, would cause the disc 10 to swing back and forth, so that the vertical elongated portions 17A and 18A of the printed wire patterns 17 and 18 are crossing the homopolar magnetic field of the magnetic plates. In this manner, current is generated in the printed wires 17 and 18.

As shown in FIG. 6, the current generated in the printed wires, schematically shown as coils 17 and 18, are fed through a rectifier bridge circuit consisting of diodes 38, 39, 40, and 41, to charge a capacitor 42 connected to the rectifier bridge. The capacitor 42 is connected to the normal DC supply terminals 43 and 44 of the remote control unit. Initially, the capacitor 42 is charged to a desired voltage by pressing and unpressing or releasing the remote control unit 37 several times. This initial charge is sufficient to provide the voltage require to operate the remote control unit when a button is pressed later to operate the remote control unit. The capacitor 42 will be recharged when the button of the remote control unit is released after it has been depressed.

The current of the printed wire patterns 17 and 18 may be conveyed to the capacitor 42 through a single rectifier diode 45 as best shown in the schematic diagram in FIG. 7 for charging it to the desired voltage.

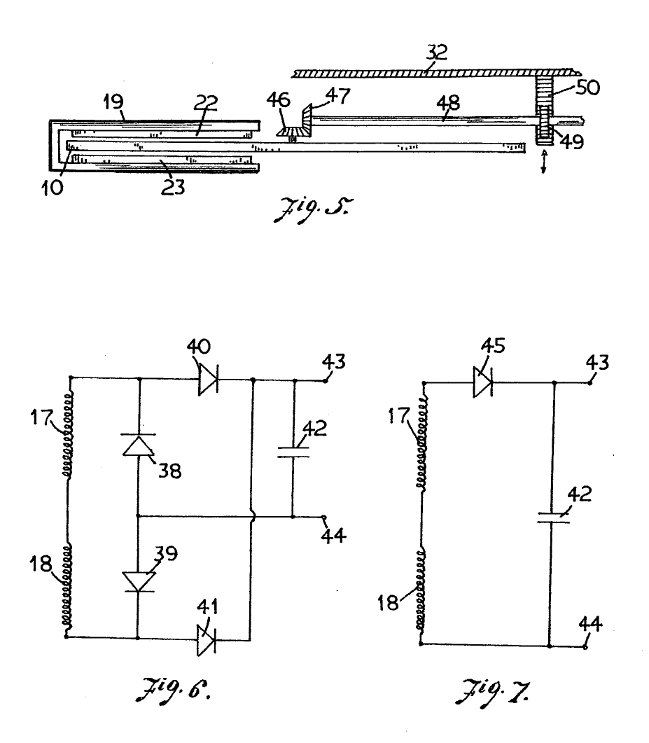

An alternative embodiment operative for rotating the disc 10 relative to the stator member 19 is shown in FIG. 5. In this embodiment, a bevel gear 46 is mounted at the center of the disc 10. The bevel gear 46 engages with a second bevel gear 47 mounted to a horizontal rotatable shaft 48 rotatably mounted to the side wall of the casing 27. A drive gear 49 is mounted on the horizontal rotatable shaft 48. The drive gear 49 engages with a vertical gear bar 50 mounted to the bottom of the tray 32. The disc 10 is normally maintained in the preferred skewed position by the spring 28 as shown in the above embodiment but in a relax state. When a button of the remote control unit is depressed, the downward movement of the tray 32 will cause the gear bar 50 to move vertically in a reciprocal manner so as to rotate the horizontal rotatable shaft 48 due to its engagement with the drive gear 49, thus it, in turn, causes the coupled bevel gears 46 and 47 to rotate the disc 10 and the tension spring 27 will be pulled by the rotation to become under tension. Subsequently, when the button of the remote control is released after it has been depressed, the spring tension of the tension spring 27 will rotate the disc 10 back to its original skewed position. Thus, current is generated in the printed wire patterns similar to the above embodiment.

The device of the present invention operates at a very high efficiency to provide the voltage required to operate the remote control unit due to the long effective length of the printed wire provided on the multi-layer disc 10. Moreover, the disc 10 only requires to move over a small degree in operation, thus the entire device may be constructed within a casing of a small physical size or even incorporated integrally in the housing of the remote control unit.

While the above description constitutes the preferred embodiments of the invention, it will be appreciated that the invention is susceptible to modifications, variation, and change without departing from the proper scope or fair meaning of the accompanying claims.

What I claim is:

1. A power generating device operative for supplying electrical power to a remote control unit, comprising
an open top casing,
a tray slidably mounted within said casing through said open top, and adapted for mounting said remote control unit thereon,
at least one compressible spring located between said casing and said tray whereby said tray is movable operatively in an up and down movement relative to said casing against a spring force of said spring,
a multi-layer disc having electrical conductor wire provided at a same one area portion in all layers therein, said disc having a center point and being rotatable relative to a mounting shaft mounted at said center point and located in said casing,
a U-shaped stator member having two parallel spaced arms and mounted in said casing, each one of said arms having a magnetic plate mounted on an inner surface therein facing one another, said one area portion of said disc being located in a spaced manner between said magnetic plates,
a mechanical rotating mechanism mounted to said disc and said tray and being operative to rotate said disc when said tray moves in said up and down movement by selectively pressing and releasing an operating button of said remote control unit,
a tension spring having one end connected to said disc and a second end connected to said casing and adapted to cooperate with said rotating mechanism in rotating said disc back and forth relative to said stator member.

2. A power generating device according to claim 1 wherein said electrical conductor wire of said disc is connected to a rectifier bridge circuit, and a capacitor electrically connected to said rectifier bridge circuit and being chargeable by electrical current generated in said electrical conductor wire when said disc rotates back and forth relative to said stator member.

3. A power generating device according to claim 2 wherein said capacitor is electrically connected to electrical supply terminals of said remote control unit.

4. A power generating device according to claim 3 wherein said one end of said tension spring is connected to a location of said disc offset from center point.

5. A power generating device according to claim 4 wherein said rotating mechanism is a string having one end connected to a second point of said disc and a second end connected to a bottom surface of said tray, said second point being offset from said center point of said disc, said string being slidable relative to a ring member fixedly mounted in said casing.

6. A power generating device according to claim 4 wherein said rotating mechanism comprises of a first bevel gear mounted to said shaft on said disc, a second bevel gear mounted on a horizontal rotary shaft and rotatably engaged with said first bevel gear, a drive gear mounted to said rotary shaft, a vertical gear bar mounted to said bottom surface of said tray engaged with said drive gear and operative cooperatively with said tension spring for rotating said disc back and forth relative to said stator member.

7. A power generating device according to claim 1 wherein said electrical conductor wire of said disc is connected to a capacitor through a diode, whereby current generated in said electrical conductor wire charges said capacitor to a selected voltage for operating said remote control unit.

8. A power generating device operative for supplying electrical power to a remote control unit, comprising
a rectangular open top casing,
a rectangular tray slidably mounted within said casing through said open top, and adapted for mounting said remote control unit thereon,
spring means located between said casing and said tray whereby said tray is movable operatively in an up and down movement relative to said casing against spring force of said spring means,
a multi-layer disc having a first spiral electrical conductor wire pattern formed at a left portion in all layers therein, and a second spiral electrical conductor wire pattern formed at a right portion in all layers therein, said first spiral electrical conductor wire pattern in all layers being connected in series and said second electrical conductor wire pattern in all layers being connected in series, and said first spiral electrical conductor pattern and said second spiral electrical conductor wire pattern being also connected in series, and said disc being rotatably mounted on a mounting shaft,
a U-shaped stator member having two parallel spaced arms and mounted in said casing, each one of said arms having a magnetic plate mounted on an inner surface therein facing one another, said disc being located in a spaced manner between said magnetic plates,
a mechanical rotating mechanism mounted to said disc and said tray and being operative to rotate said disc when said tray moves in said up and down movement by selectively pressing and releasing an operating button of said remote control unit,
a tension spring having one end connected to said disc and a second end connected to said casing and adapted to cooperate with said rotating mechanism in rotating said disc back and forth relative to said stator member for generating a current in said electrical conductor wire pattern,
a capacitor electrically connected to said electrical conductor wire pattern through a rectifier circuit whereby said capacitor is charged to an operating voltage for supplying said electrical power to said remote control unit.

9. A power generating device according to claim 8 wherein said rectifier circuit is a single diode connected in series with said first spiral electrical conductor wire pattern and said second spiral electrical conductor wire pattern.

10. A power generating device according to claim 8 wherein said rectifier circuit is a full wave rectifier bridge consisting of four diodes.
